(19) United States
(12) Patent Application Publication
(10) Pub. No.: US 2012/0218316 A1
(43) Pub. Date: Aug. 30, 2012

(54) LCD DEVICE AND DRIVING METHOD THEREOF

(75) Inventors: Nianmao Wang, Shenzhen (CN); Chengming He, Shenzhen (CN)

(73) Assignee: SHENZHEN CHINA STAR OPTOELECTRONICS TECHNOLOGY CO., LTD., Guangming dist. of Shenzhen, Guangdong (CN)

(21) Appl. No.: 13/128,551

(22) PCT Filed: Mar. 10, 2011
(86) PCT No.: PCT/CN2011/071706

§ 371 Date: May 10, 2011

(30) Foreign Application Priority Data
Feb. 24, 2011 (CN) 201110045641.5

(51) Int. Cl. G09G 5/10

(52) U.S. Cl. 345/690; 345/89

(57) ABSTRACT

The present invention provides an LCD device and a driving method thereof. The LCD device includes data lines, a source driver, pixel units, and a switching circuit connected between the source driver and the data lines. The source driver outputs gray level voltages in two adjacent data lines by using a dot inversion method. The switching circuit includes multiple first switches, multiple second switches, and multiple third switches. Before the gray level voltage is output in the data lines, the voltage level applied on the data lines approaches to the magnitude of the upcoming gray level voltage in advance. The power consumption of the LCD device of the present invention is lower.

### BACKGROUND OF THE INVENTION

1. Field of the Invention

The present invention relates to a liquid crystal display (LCD) device and its driving method.

2. Description of Prior Art

An advanced monitor with multiple functions is an important feature for use in current consumer electronic products. Liquid crystal displays (LCD devices) which are colorful monitors with high resolution are widely used in various electronic products such as monitors for mobile phones, personal digital assistants (PDAs), digital cameras, laptop computers, and notebook computers.

Referring to FIG. 1 showing a circuit diagram of a conventional liquid crystal display (LCD) device 10, the LCD device 10 comprises a timing controller 14, a source driver 16, a gate driver 18, and an LCD panel 20. The timing controller 14 generates frequency signal pulses which are transmitted to the gate driver 18. The gate driver 18 generates a scanning signal which is transmitted to the LCD panel 20. Meanwhile, the timing controller 14 outputs frequency signal pulses to the source driver 16 which outputs gray level voltage to pixel units 22 of the LCD panel 20.

Each of the pixel units 22 of the LCD panel 20 is equivalent to a circuit combination of resistors and capacitors (regarded as liquid crystal capacitors). Capacitors are charged to a desired voltage level with the gray level voltage so that liquid crystal molecules between the capacitors can rotate according to the voltage level to show different gray levels. In a case of using dot inversion to drive the LCD panel 20, the gray level voltages having opposite polarities are transmitted to two adjacent pixel units 22. The gray level voltage having a positive polarity indicates that the voltage level of the gray level voltage is higher than that of the common voltage. Contrarily, the gray level voltage having a negative polarity indicates that the voltage level of the gray level voltage is lower than that of the common voltage. The common voltage is usually half of the supply voltage applied to the source driver 16.

Referring to FIG. 2 showing a distribution of the gray level voltages versus gray levels, the source driver 16 outputs the gray level voltage having a potential V1 far away from the common voltage and the gray level voltage having a potential V2 near the common voltage respectively. In this way, the gray level voltage having a positive polarity shows black and white on the LCD panel 20 respectively. Correspondingly, the source driver 16 outputs the gray level voltage having a potential V4 far away from the common voltage and the gray level voltage having a potential V3 near the common voltage respectively. In this way, the gray level voltage having a negative polarity shows black and white on the LCD panel 20 respectively. If a pixel unit shows black after receiving the gray level voltage V1 having a positive polarity in a certain frame, the pixel unit has to receive the gray level voltage V4 having a negative polarity to maintain the same gray level values in the next frame. To change the potential V1 of the gray level voltage applied to the pixel unit to the potential V4 during a quite short charging period, it is necessary to generate a larger amount of current, which causes the increase of power consumption. In the eco-friendly era, it is an object of the industry to lower power consumption.

### SUMMARY OF THE INVENTION

An objective of the present invention is to provide an LCD device with lower power consumption to solve the technical problem that the conventional LCD device has larger power consumption.

In one aspect of the present invention, an LCD device comprises a plurality of data lines, a source driver, and a plurality of pixel units. Each of the data lines is connected to a pixel unit. The source driver comprises a plurality of amplifiers. The source driver outputs gray level voltages in two adjacent data lines by using a dot inversion method. The LCD device further comprises a switching circuit connected between the source driver and the plurality of data lines. The switching circuit comprises a first charge share capacitor, a second charge share capacitor, a plurality of first switches, a plurality of second switches, a plurality of third switches, and a plurality of fourth switches. The plurality of first switches electrically connected to odd-numbered data lines, for conducting the odd-numbered data lines and the first charge share capacitor during a first predetermined period, for being disconnected during a second predetermined period, and for conducting the odd-numbered data lines and the second charge share capacitor during a third predetermined period. The plurality of second switches electrically connected to even-numbered data lines, for conducting the even-numbered data lines and the second charge share capacitor during the first predetermined period, for being disconnected during the second predetermined period, and for conducting the even-numbered data lines and the first charge share capacitor during the third predetermined period. Each of the third switches being disposed between two adjacent data lines, for conducting the even-numbered data lines and the odd-numbered data lines during the second predetermined period. Each of the fourth switches is connected between each of the amplifiers and a corresponding data line for conducting the amplifier and the plurality of pixel units during a charging period.

In one embodiment of the present invention, the LCD device further comprises a timing controller for generating a first switching signal and a second switching signal, the first switches and the second switches are controlled by the first switching signal controlling, while the third switches are controlled by the second switching signal

In one embodiment of the present invention, the source driver outputs the gray level voltage to the data lines during the charging period, and the first, second, and third predetermined periods are arranged between two adjacent charging periods.

In one embodiment of the present invention, the timing controller is further used for generating a driving signal to control the fourth switches.

In one embodiment of the present invention, the first and second switches are two-way switches, and the third and fourth switches are one-way switches.

In another aspect of the present invention, an LCD device comprises a plurality of data lines, a source driver, and a plurality of pixel units. Each of the data lines is connected to a pixel unit. The source driver outputs gray level voltages in two adjacent data lines by using a dot inversion method. The LCD device further comprises a switching circuit connected between the source driver and the plurality of data lines. The switching circuit comprises a first charge share capacitor, a second charge share capacitor, a plurality of first switches, a plurality of second switches, and a plurality of third switches. The plurality of first switches electrically connected to odd-numbered data lines, for conducting the odd-numbered data lines and the first charge share capacitor during a first predetermined period, for being disconnected during a second predetermined period, and for conducting the odd-numbered data lines and the second charge share capacitor during a third predetermined period. The plurality of second switches electrically connected to even-numbered data lines, for conducting the even-numbered data lines and the second charge share capacitor during the first predetermined period, for being disconnected during the second predetermined period, and for conducting the even-numbered data lines and the first charge share capacitor during the third predetermined period. Each of the third switches being disposed between two adjacent data lines, for conducting the even-numbered data lines and the odd-numbered data lines during the second predetermined period.

In one embodiment of the present invention, the LCD device further comprises a timing controller for generating a first switching signal and a second switching signal, the first switches and the second switches are controlled by the first switching signal controlling, while the third switches are controlled by the second switching signal

In one embodiment of the present invention, the source driver outputs the gray level voltage to the data lines during a charging period, and the first, second, and third predetermined periods are arranged between two adjacent charging periods.

In one embodiment of the present invention, the first and second switches are two-way switches, and the third switches are one-way switches.

In one embodiment of the present invention, the switching circuit is integrated in the source driver.

In still another aspect of the present invention, a method of driving a liquid crystal display (LCD) device is provided. The LCD device comprises a plurality of data lines, a source driver, and a plurality of pixel units. Each of the data lines is connected to a pixel unit.

The source driver outputs gray level voltages in two adjacent data lines by using a dot inversion method. The method comprises the steps of: providing a first charge share capacitor, a second charge share capacitor, a plurality of first switches electrically connected to odd-numbered data lines, a plurality of second switches electrically connected to even-numbered data lines, and a plurality of third switches, each of the third switches being disposed between two adjacent data lines; during a first predetermined period controlling the plurality of first switches to conduct the odd-numbered data lines and the first charge share capacitor, and controlling the plurality of second switches to conduct the even-numbered data lines and the second charge share capacitor; during a second predetermined period controlling the plurality of third switches to conduct the even-numbered data lines and the odd-numbered data lines, controlling the plurality of first switches to disconnect the odd-numbered data lines and the first charge share capacitor, and controlling the plurality of second switches to disconnect the even-numbered data lines and the second charge share capacitor; and during a third predetermined period controlling the plurality of first switches to conducting the odd-numbered data lines and the second charge share capacitor, controlling the plurality of second switches to conduct the even-numbered data lines and the first charge share capacitor.

In one embodiment of the present invention, the source driver outputs the gray level voltage to the data lines during a charging period, and the first, second, and third predetermined periods are arranged between two adjacent charging periods.

In one embodiment of the present invention, the first and second switches are two-way switches, and the third switches are one-way switches.

In one embodiment of the present invention, the method further comprises a step of providing a plurality of fourth switches, the source driver comprising a plurality of amplifiers, each of the fourth switches being connected between each of the amplifiers and a corresponding data line for conducting the amplifier and the plurality of pixel units during the charging period. The plurality of fourth switches are one-way switches.

In contrast to the prior art, the LCD device of the present invention comprises a switching circuit to control the electrical connections between each of the data lines. Before the gray level voltage is output in the data lines, the voltage applied on the data lines changes the magnitudes of the upcoming gray level voltage in advance. In this way, the source driver can charge the pixel units on the data lines to a desired voltage level by only using a smaller amount of bias current. So the power consumption of the LCD device of the present invention is lower.

These and other features, aspects and advantages of the present disclosure will become understood with reference to the following description, appended claims and accompanying figures.

### BRIEF DESCRIPTION OF THE DRAWINGS

FIG. 1 shows a circuit diagram of a conventional liquid crystal display (LCD) device.

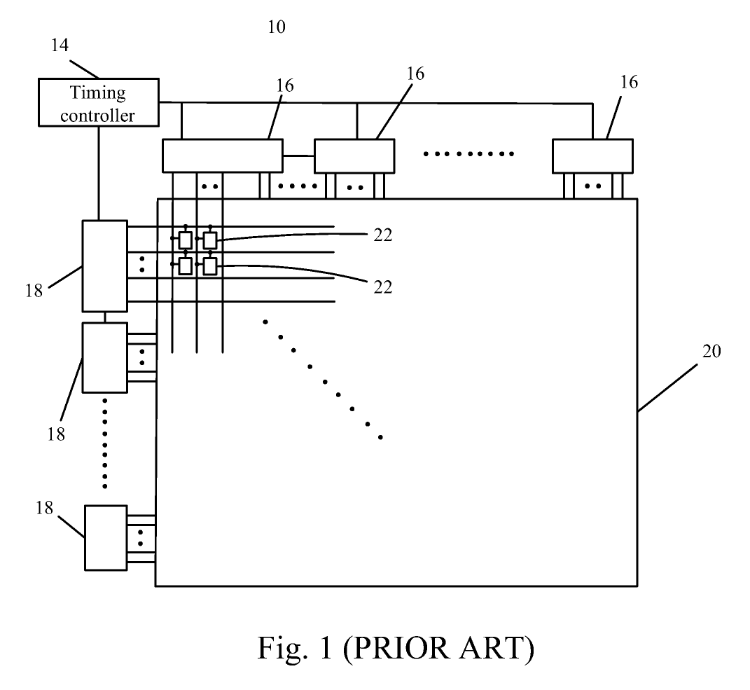

FIG. 2 shows a distribution of the gray level voltages versus gray levels.

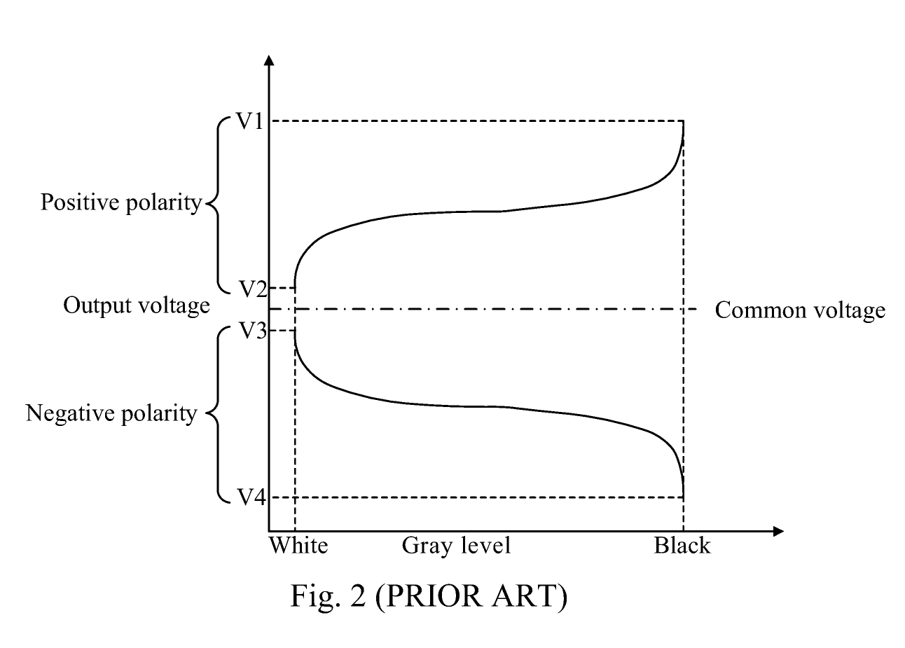

FIG. 3 shows a circuit diagram of an LCD device according to a preferred embodiment of the present invention.

FIG. 4 shows a circuit diagram of the switching circuit, the source driver, and the LCD panel in FIG. 3.

FIG. 5 shows a timing diagram of controlling signals applied on the switching circuit in FIG. 4.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

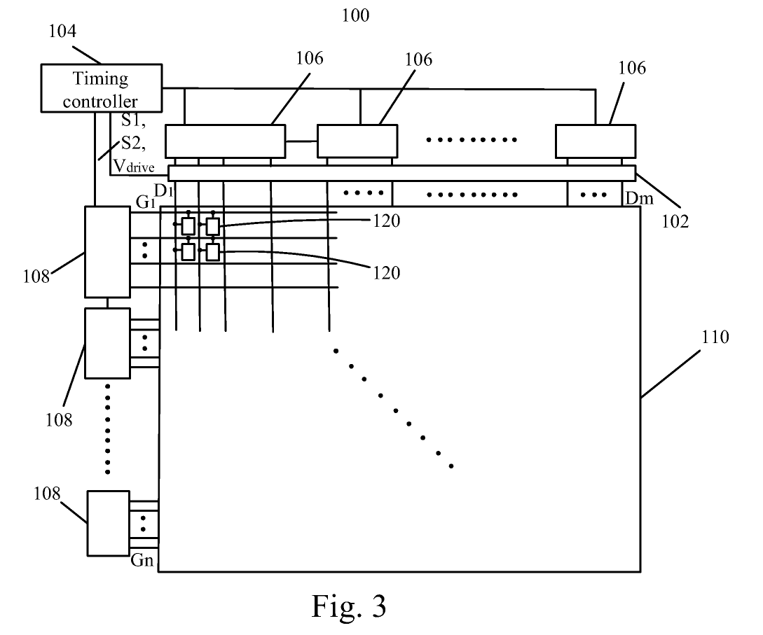

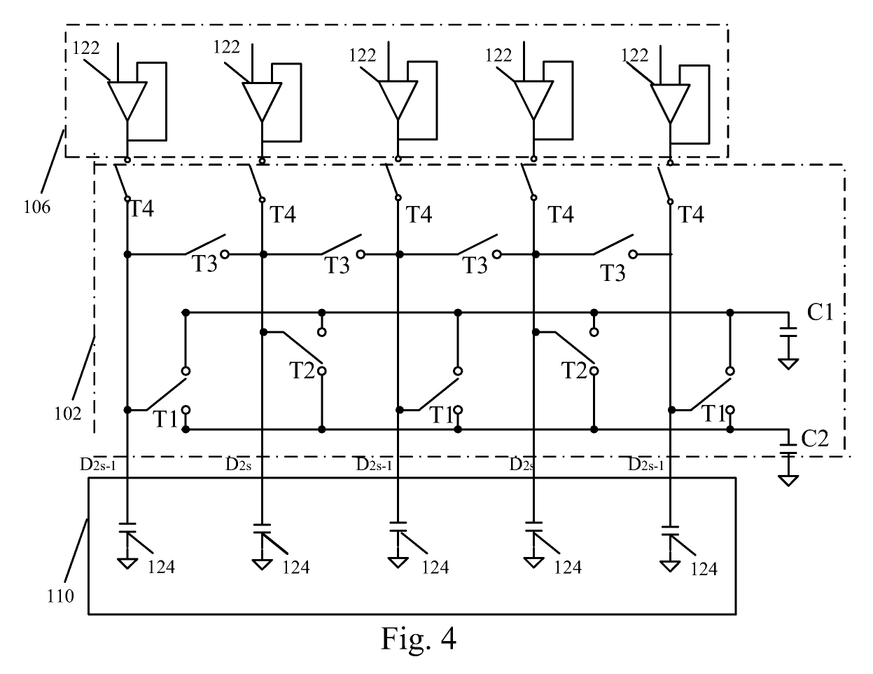

Referring to FIG. 3 showing a circuit diagram of an LCD device 100 according to a preferred embodiment of the present invention, the LCD device 100 can be a PC screen or a notebook screen. The LCD device 100 comprises a switching circuit 102, a timing controller 104, a source driver 106, a gate driver 108, and an LCD panel 110. The timing controller 104 generates a vertical synchronous signal which is transmitted to the gate driver 108. The gate driver 108 generates a scanning signal which is transmitted to the LCD panel 110 via scanning lines G1-Gn. Meanwhile, the timing controller 104 outputs a horizontal synchronous signal to the source driver 106. The source driver 106 outputs the gray level voltages to the pixel units 120 on the LCD panel 110 via data lines D1-Dm. The timing controller 104 also outputs a first switching signal S1, a second switching signal S2, and a driving signal Vdrive to the switching circuit 102. Each of the pixel unit 120 comprises a liquid crystal capacitor 124 (referring to FIG. 4 as well) which are used to display images. The source driver 106 outputs the bias currents so that the liquid crystal capacitors 124 of a row of the pixel units 120 can be charged to the voltage level of the gray level voltage to display different gray levels. The LCD panel 110 is usually driven by dot inversion. That is, two adjacent pixel units 120 receive the gray level voltages having opposite polarities. The switching circuit 102 is disposed between the source driver 106 and the plurality of data lines D1-Dm. The function of the switching circuit 102 is to control the electrical connections between each of the data lines D1-Dm in advance whenever the pixel units 120 are charged. Accordingly, the voltage applied to the data lines can change the magnitude of the gray level voltage before the gray level voltage is delivered by the data lines. So the object of electricity-saving can be achieved.

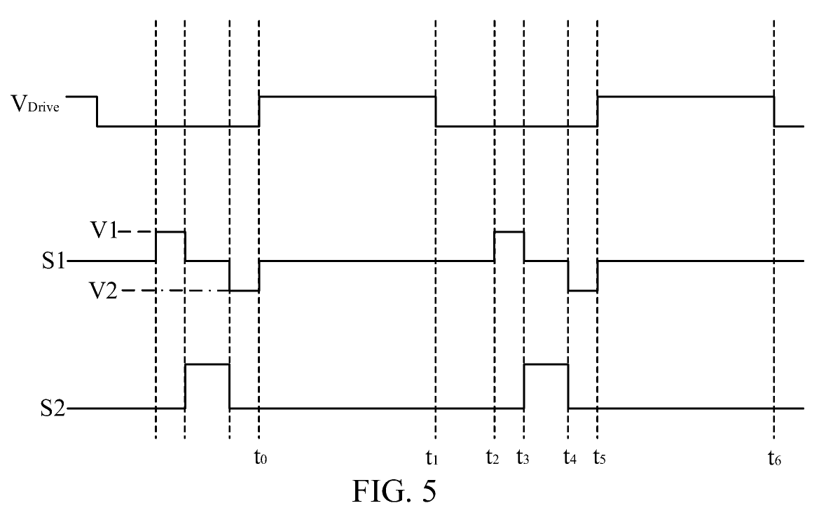

Referring to FIG. 4 showing a circuit diagram of the switching circuit 102, the source driver 106, and the LCD panel 110 in FIG. 3, and FIG. 5 showing a timing diagram of controlling signals applied on the switching circuit 102 in FIG. 4. The source driver 106 comprises a plurality of amplifiers 122. The switching circuit 102 comprises a plurality of first switches T1 electrically connected to odd-numbered data lines D₂ₛ₋₁, a plurality of second switches T2 electrically connected to even-numbered data lines D₂ₛ, a plurality of third switches T3 disposed between adjacent data lines D₂ₛ and D₂ₛ₋₁, a plurality of fourth switches T4 disposed between the amplifiers 122 and the corresponding data lines D₁-Dₘ, a first charge share capacitor C1, and a second charge share capacitor C2. The first switches T1 and the second switches T2 are two-way switches, and the third switches T3 are one-way switches. The first switches T1 and the second switches T2 are controlled by the first switching signal S1. The third switches T3 are controlled by the second switching signal S2. The fourth switches T4 are controlled by the driving signal V_{drive}. The LCD device 100 adopts dot inversion, so the gray level voltage transmitted via the odd-numbered data lines D₂ₛ₋₁ and the gray level voltage transmitted via the even-numbered data lines D₂ₛ have opposite polarities. Take FIG. 5 for example. During a charging period t₀-t₁, the gray level voltage having a negative polarity is transmitted via the odd-numbered data lines D₂ₛ₋₁, and the gray level voltage having a positive polarity is transmitted via the even-numbered data lines D₂ₛ. During a next charging period t₅-t₆, the gray level voltage having a positive polarity is transmitted via the odd-numbered data lines D₂ₛ₋₁, and the gray level voltage having a negative polarity is transmitted via the even-numbered data lines D₂ₛ.

During a pre-charging period (i.e., t₂-t₅) between every two charging periods, the switching circuit 102 adjusts the voltage level of the odd-numbered data lines D₂ₛ₋₁ and the voltage level of the even-numbered data lines D₂ₛ to reduce power consumption. Please refer to the descriptions below. During the period t₁-t₅, the driving signal V_{drive} which controls the fourth switch T4 is situated at the low voltage level and the fourth switch T4 is disconnected, so the gray level voltage is not applied on the data lines D₁-Dₘ from the source driver 106. During the period t₁-t₂, not only the fourth switch T4 but also the first switch T1, the second switch T2, and the third switch T3 are disconnected, so the gray level voltage is not applied on the data lines D₁-Dₘ from the source driver 106. Meanwhile, the switching circuit 102 turns off. The source driver 106 holds the gray level voltage during the next charging period t₅-t₆ so that the gray level voltage can be applied on the data lines D₁-Dₘ during the next charging period t₅-t₆.

During a first predetermined period t₂-t₃, the third switch T3 receives the second switching signal S2 at the low voltage level (e.g. ground voltage), and the first switch T1 and the second switch T2 receive the first switching signal S1 at the first voltage level V1. Accordingly, the third switches T3 turn off. The plurality of first switches T1 electrically connect the odd-numbered data lines D₂ₛ₋₁ and the first charge share capacitor C1. Meanwhile, the second switches T2 electrically connect even-numbered data lines D₂ₛ and the second charge share capacitor C2. Preferably, the capacitances of the first charge share capacitor C1 and of the second charge share capacitor C2 is much larger than the loading capacitor of the data lines D₂ₛ and of the data lines D₂ₛ₋₁ and the liquid crystal capacitor 124 of the pixel units 120. So the charge held in the odd-numbered data lines D₂ₛ₋₁ is shared with the first charge share capacitor C1, and the charge held in the even-numbered data lines D₂ₛ is shared with the second charge share capacitor C2. During the charging period t₀-t₁, the gray level voltage having a negative polarity is transmitted via the odd-numbered data lines D₂ₛ₋₁, so the potential of the first charge share capacitor C1 is lower than the common voltage after the charge is shared. Relatively, the gray level voltage having a positive polarity is transmitted via the even-numbered data lines D₂ₛ, so the potential of the second charge share capacitor C2 is higher than the common voltage after the charge is shared.

During a second predetermined period t₃-t₄, the third switch T3 receives the second switching signal S2 at the high voltage level. Meanwhile, the first switch T1 and the second switch T2 receive the first switching signal S1 at the second voltage level (e.g. the ground voltage). The first switches T1 and the second switches T2 turn off, and the third switches T3 electrically connect all of the data lines, resulting in the odd-numbered data lines D₂₋₁ and the even-numbered data lines D₂ₛ being at the same voltage level.

During a third predetermined period t₄-t₅, the third switch T3 receives the second switching signal S2 at the low voltage level (e.g. ground voltage), and the first switch T1 and the second switch T2 receive the first switching signal Si at the third voltage level V2. Accordingly, the third switches T3 turn off. The first switches T1 electrically connect the odd-numbered data lines D₂ₛ₋₁ and the second charge share capacitor C2. Meanwhile, the second switches T2 electrically connect the even-numbered data lines D₂ₛ, and the first charge share capacitor C1. Since the potential of the first charge share capacitor C1 is lower than the common voltage, the voltage level of the even-numbered data lines D₂ₛ is drawn downwards by the first charge share capacitor C1 to a level slightly lower than the common voltage before the next charging period t₅-t₆, i.e., the fourth predetermined period. Furthermore, since the potential of the second charge share capacitor C2 is higher than the common voltage during the period t₂-t₃, the voltage level of the odd-numbered data lines D₂ₛ₋₁ is drawn upwards by the second charge share capacitor C2 to a level slightly higher than the common voltage before the next charging period t₅-t₆.

As mentioned above, the gray level voltage having a positive polarity is transmitted via the odd-numbered data lines D₂ₛ₋₁, and the gray level voltage having a negative polarity is transmitted via the even-numbered data lines D₂ₛ during the charging period t₅-t₆. The voltage level of the odd-numbered data lines D₂ₛ₋₁ has been slightly higher than the common voltage, and the voltage level of the even-numbered data lines D₂ₛ has been slightly lower than the common voltage, so the source driver 106 only needs a small amount of bias currents to let the pixel units 120 on the odd-numbered data lines D₂ₛ₋₁ or on the even-numbered data lines D₂ₛ be charged to their required voltage level. In contrast to the prior art, the LCD device of the present invention can reduce power consumption.

The LCD device of the present invention is not limited to the above-mentioned implementation. For example, the switching circuit 102 can also be integrated in the source driver 106. The operational principles are the same.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display (LCD) device, comprising a plurality of data lines, a source driver, and a plurality of pixel units, each of the data lines being connected to a pixel unit, the source driver comprising a plurality of amplifiers, the source driver outputting gray level voltages in two adjacent data lines by using a dot inversion method, characterized in that: the LCD device further comprises a switching circuit connected between the source driver and the plurality of data lines, the switching circuit comprising:
a first charge share capacitor and a second charge share capacitor;
a plurality of first switches, electrically connected to odd-numbered data lines, for conducting the odd-numbered data lines and the first charge share capacitor during a first predetermined period, for being disconnected during a second predetermined period, and for conducting the odd-numbered data lines and the second charge share capacitor during a third predetermined period;
a plurality of second switches, electrically connected to even-numbered data lines, for conducting the even-numbered data lines and the second charge share capacitor during the first predetermined period, for being disconnected during the second predetermined period, and for conducting the even-numbered data lines and the first charge share capacitor during the third predetermined period;
a plurality of third switches, each of the third switches being disposed between two adjacent data lines, for conducting the even-numbered data lines and the odd-numbered data lines during the second predetermined period; and
a plurality of fourth switches, each of the fourth switches being connected between each of the amplifiers and a corresponding data line for conducting the amplifiers and the plurality of pixel units during a charging period.

2. The LCD device of claim 1, characterized in that: the LCD device further comprises a timing controller for generating a first switching signal and a second switching signal, the first switches and the second switches are controlled by the first switching signal, the third switches are controlled by the second switching signal.

3. The LCD device of device claim 1, characterized in that: the source driver outputs the gray level voltage to the data lines during the charging period, and the first, second, and third predetermined periods are arranged between two adjacent charging periods.

4. The LCD device of claim 1, characterized in that: the timing controller is further used for generating a driving signal to control the fourth switches.

5. The LCD device of claim 1, characterized in that: the first and second switches are two-way switches, and the third and fourth switches are one-way switches.

6. A liquid crystal display (LCD) device, comprising a plurality of data lines, a source driver, and a plurality of pixel units, each of the data lines being connected to a pixel unit, the source driver outputting gray level voltages in two adjacent data lines by using a dot inversion method, characterized in that: the LCD device further comprises a switching circuit connected between the source driver and the plurality of data lines, the switching circuit comprising:
a first charge share capacitor and a second charge share capacitor;
a plurality of first switches, electrically connected to odd-numbered data lines, for conducting the odd-numbered data lines and the first charge share capacitor during a first predetermined period, for being disconnected during a second predetermined period, and for conducting the odd-numbered data lines and the second charge share capacitor during a third predetermined period;
a plurality of second switches, electrically connected to even-numbered data lines, for conducting the even-numbered data lines and the second charge share capacitor during the first predetermined period, for being disconnected during the second predetermined period, and for conducting the even-numbered data lines and the first charge share capacitor during the third predetermined period; and
a plurality of third switches, each of the third switches being disposed between two adjacent data lines, for conducting the even-numbered data lines and the odd-numbered data lines during the second predetermined period.

7. The LCD device of claim 6, characterized in that: the LCD device further comprises a timing controller for generating a first switching signal and a second switching signal, the first switches and the second switches are controlled by the first switching signal, the third switches are controlled by the second switching signal.

8. The LCD device of device claim 6, characterized in that: the source driver outputs the gray level voltage to the data lines during a charging period, and the first, second, and third predetermined periods are arranged between two adjacent charging periods.

9. The LCD device of claim 6, characterized in that: the first and second switches are two-way switches, and the third switches are one-way switches.

10. The LCD device of claim 6, characterized in that: the switching circuit is integrated in the source driver.

11. A method of driving a liquid crystal display (LCD) device, the LCD device comprising a plurality of data lines, a source driver, and a plurality of pixel units, each of the data lines being connected to .a pixel unit, the source driver outputting gray level voltages in two adjacent data lines by using a dot inversion method, the method of driving the LCD device comprising the following steps of:
providing a first charge share capacitor, a second charge share capacitor, a plurality of first switches electrically connected to odd-numbered data lines, a plurality of second switches electrically connected to even-numbered data lines, and a plurality of third switches, each of the third switches being disposed between two adjacent data lines;
during a first predetermined period controlling the plurality of first switches to conduct the odd-numbered data lines and the first charge share capacitor, and controlling the plurality of second switches to conduct the even-numbered data lines and the second charge share capacitor;
during a second predetermined period controlling the plurality of third switches to conduct the even-numbered data lines and the odd-numbered data lines, controlling the plurality of first switches to disconnect the odd-numbered data lines and the first charge share capacitor, and controlling the plurality of second switches to disconnect the even-numbered data lines and the second charge share capacitor; and
during a third predetermined period controlling the plurality of first switches to conducting the odd-numbered data lines and the second charge share capacitor, controlling the plurality of second switches to conduct the even-numbered data lines and the first charge share capacitor.

12. The method of driving the LCD device of claim 11, characterized in that: the source driver outputs the gray level voltage to the data lines during a charging period, and the first, second, and third predetermined periods are arranged between two adjacent charging periods.

13. The method of driving the LCD device of claim 12, characterized in that: the first and second switches are two-way switches, and the third switches are one-way switches.

14. The method of driving the LCD device of claim 12, characterized in that:
providing a plurality of fourth switches, the source driver comprising a plurality of amplifiers, each of the fourth switches being connected between each of the amplifiers and a corresponding data line for conducting the amplifiers and the plurality of pixel units during the charging period.

15. The method of driving the LCD device of claim 14, characterized in that: the plurality of fourth switches are one-way switches.
